(19) United States
(12) Patent Application Publication
(10) Pub. No.: US 2019/0195401 A1
(43) Pub. Date: Jun. 27, 2019

(54) SEALING RING

(71) Applicant: JUN HE TECHNOLOGY CO., LTD., CHANGHUA COUNTY (TW)

(72) Inventor: CHIANG-CHUAN WANG, Lukang Township (TW)

(21) Appl. No.: 16/040,346

(22) Filed: Jul. 19, 2018

(30) Foreign Application Priority Data
Dec. 22, 2017 (TW) 106219053

(51) Int. Cl. F16L 21/03; F16L 47/10; F16L 19/02

(52) U.S. Cl. CPC F16L 21/03; F16L 17/035; F16L 19/0218; F16L 47/10

(57) ABSTRACT

A sealing ring has a circular ring with a circular outer edge and a circular inner edge. The circular ring further has a first curved surface and a second curved surface between the circular outer edge and the circular inner edge. The circular outer edge, the first curved surface and the second curved surface have curved cross-sectional shapes. The circular ring further has a circular recess on the circular inner edge. The circular ring also has a circular protrusion on the circular recess respectively adjacent to the first curved surface and the second curved surface.

### BACKGROUND of INVENTION

### 1. Field of Invention

The present invention relates to a sealing ring, and more particularly to a sealing ring without parting line issues.

### 2. Description of Related Art

As shown in FIGS. 8 and 9, a sealing ring 30 is commonly used in pipe joints, and the sealing ring 30 is used for leakage prevention purposes. The conventional sealing ring 30 has a circular cross section. However, the sealing ring 30 is generally formed by a combination of an upper mold cover and a lower mold having the shape of the sealing ring 30. After the mold is opened, a parting line 31 is formed at the middle of the inner and outer circumferences of the sealing ring 30. The mold line is inevitably produced only during production. Now, the surface of the sealing ring often has unevenness, and a further removal process of the parting line 31 will greatly increase the production cost of the sealing ring 30. If the parting line 31 is not removed, the parting line 31 will directly contact the pipe which is prone to deformation, breakage or wear. When parting line 31 contacts and rubs the pipeline, the sealing ring has a poor leakage prevention effect. Further, in as shown in FIGS. 10 and 11, the sealing ring 30 is assembled inside a tubular body 41 of a quick-assembly joint 40, then a retaining ring 42 and a claw ring 43 are sequentially loaded into the tubular body 41, and a cover 44 is welded and fixed to the opening of the tubular body 41. The cover sleeve 44 is provided with a pressing sleeve 45, and a connecting tube 46 is continuously passed from an end of the pressing sleeve 45 through the claw ring 43, the retaining ring 42 and the sealing ring 30. The connecting pipe 46 can be secured by the claw ring 43 and released by the pressing sleeve 45. In actual operation, the connecting pipe 46 interferes with the parting line 31 of the sealing ring 30 when is inserted into the tubular body 41. The parting line 31 may cause leakage due to uneven shape of the parting line 31, or friction during insertion may cause breakage or deformation of the parting line 31, causing the sealing ring 30 to lose leakage prevention function. The quick-assembly joint 40 is not removable and the sealing ring also cannot be replaced. If the sealing ring does not have a leak-proof effect, the entire quick-assembly joint 40 needs to be replaced, and the durability of the quick-assembly joint 40 is lowered.

Therefore, it is desirable to provide a sealing ring to mitigate and/or obviate the aforementioned problems.

### SUMMARY of INVENTION

An objective of present invention is to provide a floor mat puzzle having a non-rectangular isometric polygonal mat, which is capable of improving the above-mention problems.

In order to achieve the above mentioned objective, a sealing ring has a circular ring with a circular outer edge and a circular inner edge. The circular ring further has a first curved surface and a second curved surface between the circular outer edge and the circular inner edge. The circular outer edge, the first curved surface and the second curved surface have curved cross-sectional shapes. The circular ring further has a circular recess on the circular inner edge. The circular ring also has a circular protrusion on the circular recess respectively adjacent to the first curved surface and the second curved surface.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment of the present invention.

FIG. 2 shows a mold for making the preferred embodiment of the present invention.

FIG. 3 is a schematic drawing of a mold making the preferred embodiment of the present invention.

FIG. 4 is a cross-sectional view of the preferred embodiment of the present invention.

FIG. 5 is a perspective exploded view of the quick-assembly joint.

FIG. 6 is a cross-sectional view of the assembly of the preferred embodiment applied to the quick-assembly joint.

FIG. 7 is a cross-sectional view of the assembled quick-assembly joint of the preferred embodiment.

FIG. 8 is a perspective view of a prior art sealing ring.

FIG. 9 is a cross-sectional view of the prior art sealing ring.

FIG. 10 is a perspective exploded view of the prior art sealing ring being applied to the quick-assembly joint.

FIG. 11 is a cross-sectional view of the prior art sealing ring being applied to the quick-assembly joint.

### DETAILED DESCRIPTION OF PREFERRED EMBODIMENT

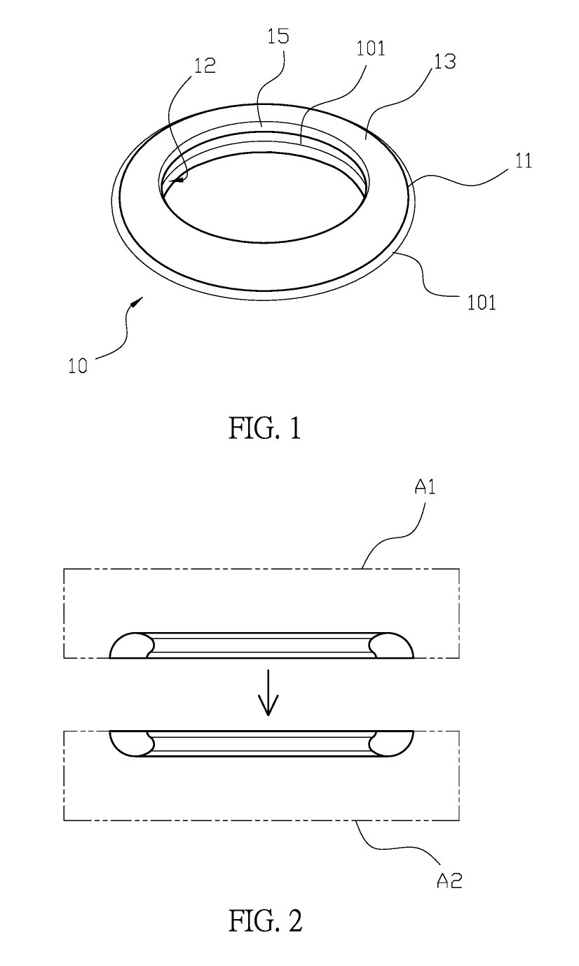

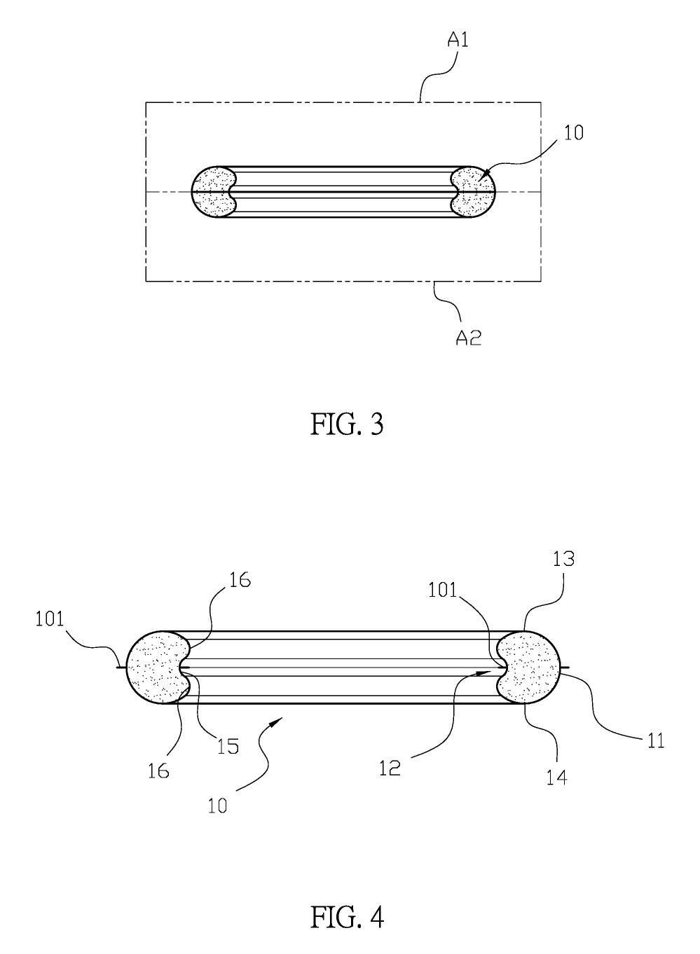

Please refer to FIG. 1 to FIG. 4. A sealing ring comprises a circular ring 10 has a circular outer edge 11 and a circular inner edge 12. The circular ring 10 is further provided with a first curved surface 13 and a second curved surface 14 between the circular outer edge 11 and the circular inner edge 12. The circular ring 10 respectively has a curved cross-sectional shape at the circular outer edge 11, the first curved surface 13 and the second curved surface 14. The circular ring 10 further comprises a circular recess 15 on the circular inner edge 12. And the circular ring 10 also having a circular protrusion 16 on the circular recess 15 respectively adjacent to the first curved surface 13 and the second curved surface 14. The circular recess 15 and the two circular protrusions 16 all respectively have curved cross-sectional shapes. The circular ring 10 the sealing ring is molded by an upper mold A1 and a lower mold A2 together, and a parting line 101 is formed on the circular recess 16. The circular recess 15 of the circular ring 10 contains the parting line 101. Another parting line 101 is formed on the circular outer edge 11 of the circular ring 10, which does not change the sealing effect.

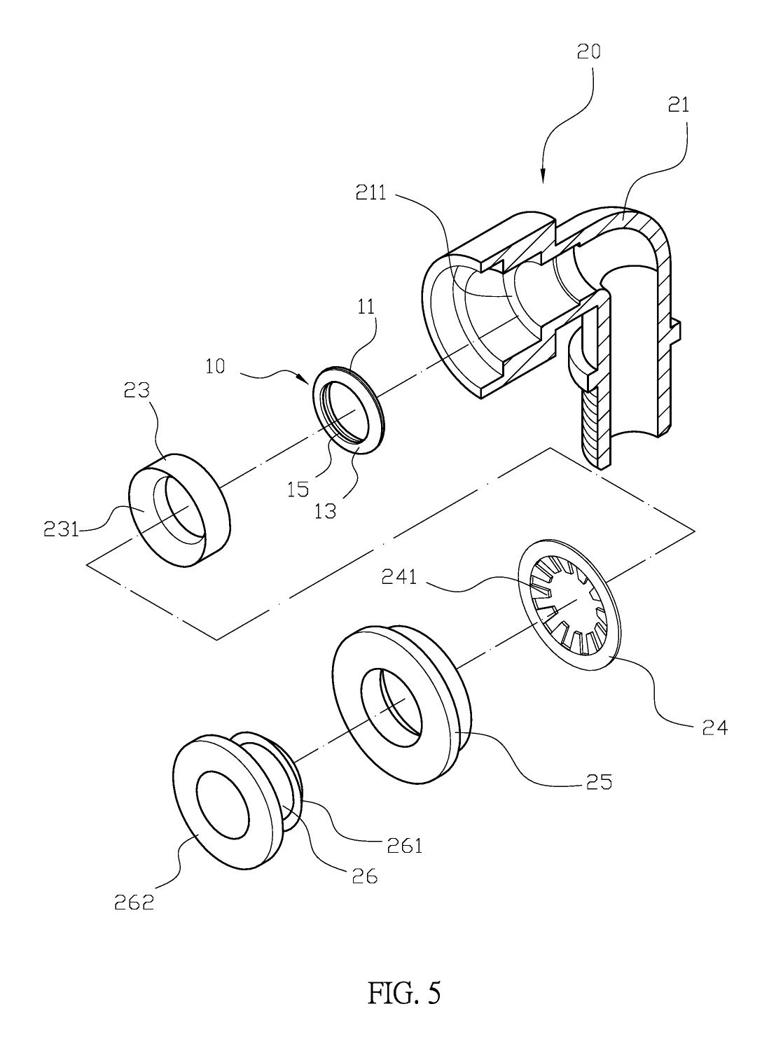

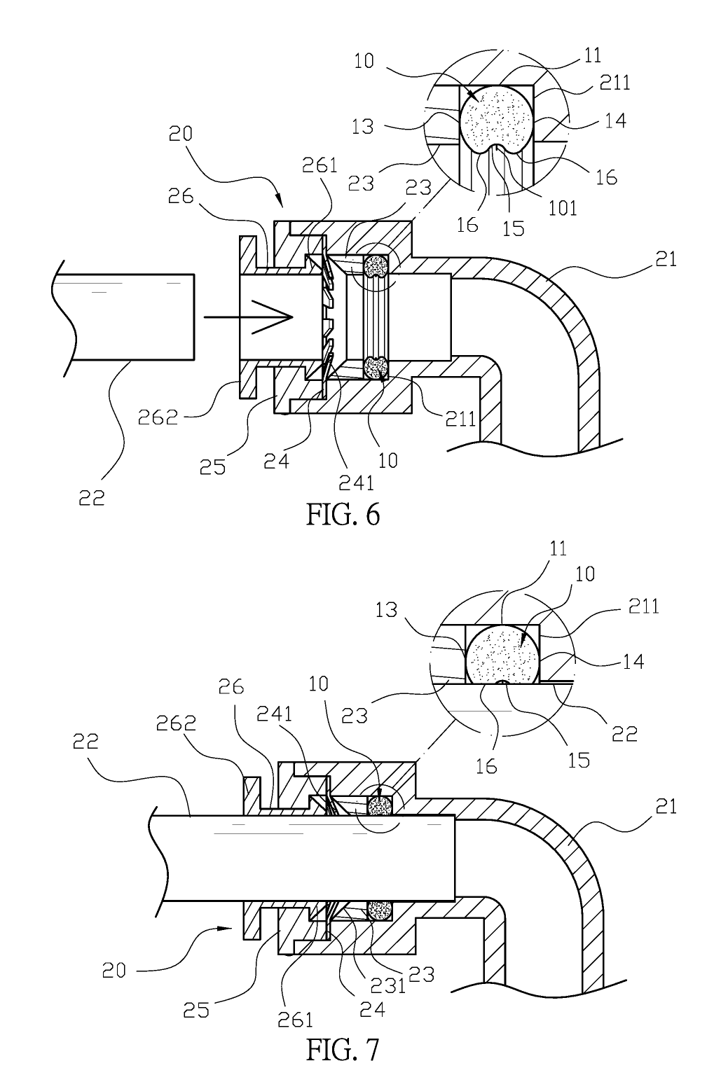

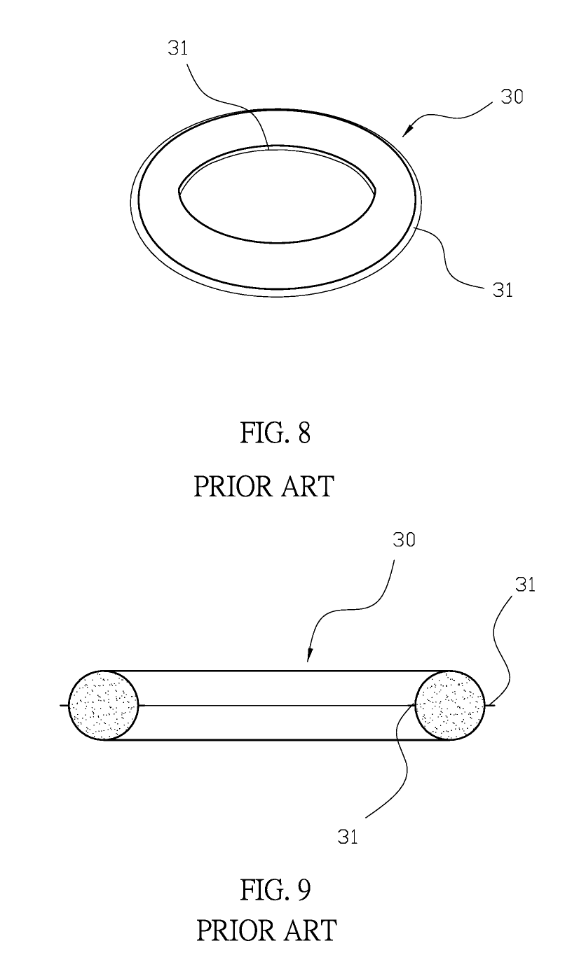

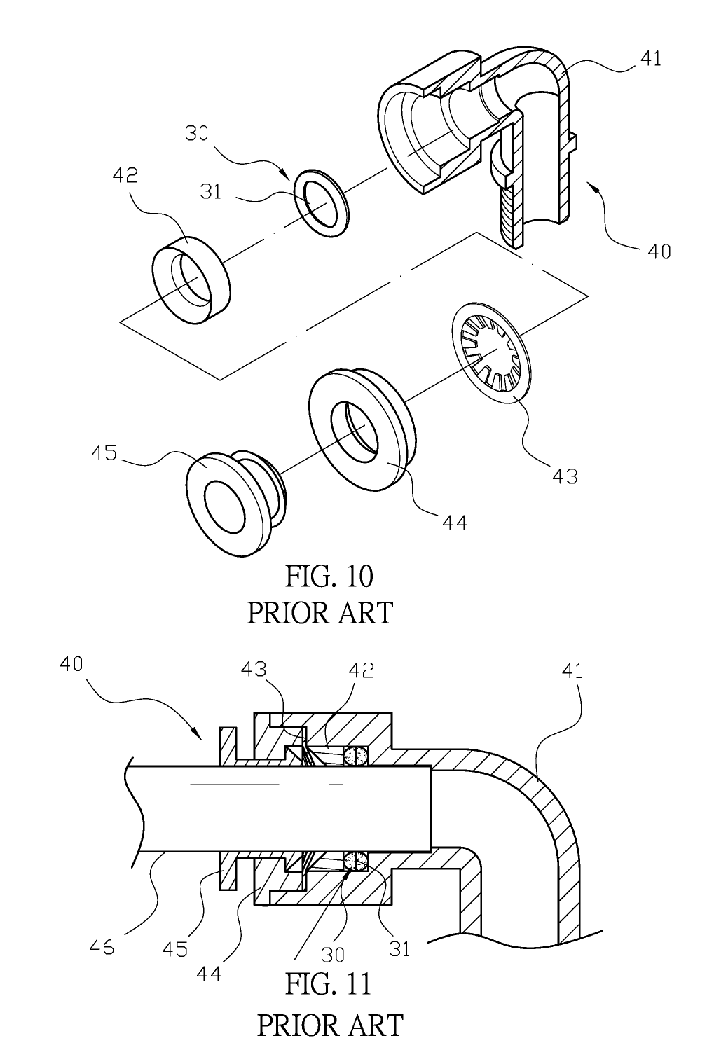

For actual operation, please refer to FIG. 4 to FIG. 7. The circular ring 10 is configured for installation in a quick-assembly joint 20. The quick-assembly joint 20 comprises a tubular body 21 and a circular body 22, and the tubular body 21 is provided with a positioning portion 211 at an inner edge. The circular ring 10 is mounted at the positioning portion 211, the circular body 22 inserted into the tubular body 21, the circular outer edge 11 of the circular ring 10 pushing against the tubular body 21, and the circular protrusion 16 of the circular ring 10 pushes against the circular body 22. The circular body 22 can be a water pipe or a vent pipe. Since the parting line 101 of the circular ring 10 is formed in the circular recess 15 not touching the circular body 22, which prevents the parting line 101 from uneven shape, deformation, breakage or wear and tear that leads to lack of leakage prevention effect. When the circular ring 10 is no longer affected by the parting line 101, the production yield and stability of the circular ring 10. Furthermore, the quick-assembly joint 20 further comprises a positioning loop 23, an engaging loop 24, a securing sleeve 25 and a quick-release ring 26. The positioning loop 23 is contained in the tubular body 21 corresponding to the positioning portion 211 to secure the first curved surface 13 and the second curved surface 14 of the circular ring 10. The engaging loop 24 is placed in the tubular body 21, the securing sleeve 25 stops the engaging loop 24, the quick-release ring 26 is jacketed on the securing sleeve 25, and the circular body 10 is placed through the quick-release ring 26, the positioning loop 23 and the engaging loop 24. The engaging loop 24 is configured for securing the circular body 22, so the circular body 22 can only be inserted not pulled out. The quick-release ring 26 is configured for release the engagement between the engaging loop 24 and the circular body 22. The engaging loop 24 has a plurality of securing claws 241 facing opposite the securing sleeve 25, and the positioning loop 23 further has a flange 231 facing the engaging loop 24. The flange 241 allows the securing claws 231 to flexibly engage thereof. The quick-release ring 26 has a cone-shaped end 261, and another end of the quick-release ring 26 is further provided with a pressing portion 262. The cone-shaped end 261 of the quick-release ring 26 is mounted in the tubular body 21, and the pressing portion 262 is jacketed onto the tubular body 21. The pressing portion 262 of the quick-release ring 26 pushes against the claw 241 of the engaging loop 24 with the cone-shaped end 261, so that the claw 241 does not contact the circular body 22, therefore the circular body 22 can be quickly drawn from the tubular body 21. Moreover, the securing sleeve 25 is welded onto an opening of the tubular body 21, and the cone-shaped end 261 of the quick-release ring 26 is subjected to the securing sleeve 25 and unable to be pulled away. The securing claws 241 of the engaging loop 24 push against the quick-release ring 26, so that the quick-release ring 26 is normally un-pressed. The circular ring 10 installed in the quick-assembly joint 20 is not replaceable. The circular body 22 can be assembled onto the tubular body 21 as many time as needed. Since the parting line 101 is contained in the circular recess 15 of the circular ring 10, so that the circular body 22 only make contact with the circular protrusion 16. Therefore, the durability of the quick-assembly joint 20 is improved by the circular ring 10.

Although the present invention has been explained in relation to its preferred embodiment, it is to be understood that many other possible modifications and variations can be made without departing from the spirit and scope of invention as hereinafter claimed.

What is claimed is:

1. A sealing ring comprising:
a circular ring with a circular outer edge and a circular inner edge, the circular ring further having a first curved surface and a second curved surface between the circular outer edge and the circular inner edge; the circular outer edge, the first curved surface and the second curved surface having curved cross-sectional shapes; the circular ring further having a circular recess on the circular inner edge; and the circular ring also having a circular protrusion on the circular recess respectively adjacent to the first curved surface and the second curved surface.

2. The sealing ring as claimed in claim 1, wherein the circular recess and the two circular protrusions all respectively have curved cross-sectional shapes.

3. The sealing ring as claimed in claim 1, wherein the circular ring is molded by an upper mold and a lower mold together, and a parting line is formed on the circular recess.

4. The sealing ring as claimed in claim 1, wherein the circular ring is configured for installation in a quick-assembly joint.

5. The sealing ring as claimed in claim 4, wherein the quick-assembly joint comprises a tubular body and a circular body, the tubular body provided with a positioning portion at an inner edge, and the circular ring is mounted at the positioning portion, the circular body inserted into the tubular body, the circular outer edge of the sealing ring pushing against the tubular body, and the circular protrusion of the circular ring pushes against the circular body.

6. The sealing ring as claimed in claim 5, wherein the quick-assembly joint further comprises: a positioning loop, an engaging loop, a securing sleeve and a quick-release ring; the positioning loop is contained in the tubular body corresponding to the positioning portion to secure the first curved surface and the second curved surface of the circular ring, the engaging loop placed in the tubular body, the securing sleeve stopping the engaging loop, the quick-release ring is jacketed on the securing sleeve, and the circular body is placed through the quick-release ring, the positioning loop and the engaging loop.

7. The sealing ring as claimed in claim 6, wherein the engaging loop further comprises a plurality of securing claws, and the positioning loop further comprises a flange.

8. The sealing ring as claimed in claim 7, wherein the quick-release ring has a cone-shaped end, and another end of the quick-release ring is further provided with a pressing portion; the cone-shaped end of the quick-release ring is mounted in the tubular body, and the pressing portion is jacketed onto the tubular body.

9. The sealing ring as claimed in claim 8, wherein the securing sleeve is welded onto an opening of the tubular body, and the cone-shaped end of the quick-release ring is blocked by the securing sleeve.
